(19) United States
(12) Patent Application Publication
(10) Pub. No.: US 2013/0110588 A1
(43) Pub. Date: May 2, 2013

(54) Application usage and process monitoring in an enterprise environment

(71) Applicants: Eshai Livne, Karkour (IL); Yizhar Ronen, Kibbutz Ein-Shemer (IL); Brenda Kay Hansen, Salt Lake City, UT (US); Paul Harold Leamon, McKinney, TX (US)

(72) Inventors: Eshai Livne, Karkour (IL); Yizhar Ronen, Kibbutz Ein-Shemer (IL); Brenda Kay Hansen, Salt Lake City, UT (US); Paul Harold Leamon, McKinney, TX (US)

(73) Assignee: IEX CORPORATION, Richardson, TX (US)

(21) Appl. No.: 13/282,047

(22) Filed: Oct. 26, 2011

(51) Int. Cl. G06Q 10/06

(52) U.S. Cl. 705/7.38

(57) ABSTRACT

A real-time activity monitor (RTAM) operates within or in association with a machine (such as a desktop) within a back office environment to automatically track and record desktop processing activities, application usage, as well as manual processing. The real-time activity monitor provides visibility into real-time task processing at the client desktop to enable an enterprise to address back office operational inefficiencies that are exposed by the data.

### BACKGROUND OF THE INVENTION

1. Technical Field

The disclosed subject matter relates generally to computer-implemented monitoring of agent performance within an enterprise (e.g., back office) workplace environment.

2. Background of the Related Art

Workforce management systems are well-known in the prior art. Such systems integrate many management functions, such as workforce forecasting and scheduling, skill planning and scheduling, multimedia contact management, and the like. A representative commercial system of this type is TotalView® workforce management, from IEX Corporation. Workforce Management software enables even the most complex multi-site, multi-skill and multi-channel contact centers to forecast staffing needs, schedule their representatives' time, and effectively manage change every day.

An enterprise's back office operations often are out of sight, but to corporate management, they are rarely out of mind. An enterprise's back office staff typically handles the work that is designed to keep the business running smoothly and efficiently. These include, for example, processing insurance claims and associated payments, home loan applications, credit card applications, complicated help desk trouble tickets that require various off-phone research and analysis work, and the like. Ably managing the back office requires accurate forecasting and scheduling that balances workload with staffing resources, as well as capturing and understanding employee activity.

Historically, the contact center was the epicenter of the workforce management revolution, and for good reason. In the contact center, seconds count. Customer contacts come with high volume and frequency, and the issues they represent often require immediate resolution. Thus, the need arose to develop techniques to monitor agent activities, refine predictions of contact patterns and resolution times, and optimize agents' time to meet demand. Meanwhile, however, the sophistication of back office management information and management information systems has lagged. Compared to the copious amount of data collected and processed about contact center operations, the back office provides little or no comparable information.

To address this problem, it is desirable to implement robust and scalable desktop application monitoring so that back office managers can obtain an accurate view of the time employees take to complete tasks that are required to complete one or more defined business processes.

### BRIEF SUMMARY

A real-time activity monitor (RTAM) operates within or in association with a machine (such as a desktop personal computer or PC) within a back office environment to automatically track and record desktop processing activities, application usage, as well as allowing data entry for manual processing. The real-time activity monitor provides visibility into real-time task processing at the client desktop to enable an enterprise to address back office operational inefficiencies that are exposed by the data.

Preferably, the data collection and display techniques herein are based on the concept of a business office work item. These work items may go through multiple teams or steps before they are completed. For example, a home loan may first go through a loan application review team, then to an underwriting team, then to a processing team, and then to a funding team. An employee may or may not have multiple skills to work on multiple processing teams or steps. Within each step is a business office “process.” Thus, for example, a “process” may refer to a back office business process that comprises a set of “tasks.” A “process” has a “start” and an “end,” and typically one or more local or remotely-accessible applications may be used to carry out the process. An employee may operate on several business processes concurrently. In the alternative, a single work item may have a review step that corresponds to the “claim review” business process, in which case it may be required that more than one person review the claim before it can be completed. Therefore, a work item being processed in a step may be “touched” by multiple employees before it can be said to be completed. These “touches” are referred to as a business process instance. In addition, single touches in a business process step by the same employee for different work items are also business process instances, as well as multiple touches for the same item by the same employee. For example, an employee might start reviewing a claim just before the end of their work day, then he or she may finish it the beginning of his or her next work day.

In a representative embodiment, a real-time activity monitor is implemented as several functions that operate on the client desktop, namely: a business “process” monitor, an application monitor, and an employee work journal. The process monitor captures and records applications and activities on the client desktop, including, without limitation, the execution of business processes (including concurrent processes) and tasks associated with a process. The application monitor tracks active applications and web page usage, including across remote environments. A business rule engine facilitates the data collection, and system reports intelligently visualize employee work.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is an illustrative enterprise machine and server architecture in which the disclosed subject matter may be implemented;

FIG. 2 illustrates a representative implementation of a real-time activity monitor (RTAM) that is integrated with a workforce management (WFM) system;

FIG. 3 illustrates a high level operation of a desktop process monitor and application process monitor according to this disclosure;

FIG. 4 is a block diagram of a process monitor and an application monitor of the desktop client application of this disclosure;

FIG. 5 illustrates the basic operation(s) of the process and application monitors of FIG. 4;

FIG. 6 illustrates a representative Average Task Duration display view generated by the desktop process monitor (DPM) data collection process;

FIG. 7 illustrates a representative Average application Usage display view generated by the desktop application monitor (DAM) application data collection process;

FIG. 8 illustrates a representative process monitoring model of this disclosure;

FIG. 9 illustrates a representative application monitoring model of this disclosure;

FIG. 10 illustrates a table of data structures for use in aggregating task event data according to the data model;

FIG. 11 is a representative scenario illustrating how the disclosed technique is used to capture event data generated while an employee executes multiple, concurrent business processes on the desktop;

FIG. 12 is a representative total work item handling duration or “touch” report that illustrates work time taken to complete a particular work item when multiple employees touch that item; and

FIG. 13 is a representative display screen and input mechanism for use to collect data for an employee work journal.

### DETAILED DESCRIPTION OF AN ILLUSTRATIVE EMBODIMENT

As noted above, preferably the data collection and display techniques herein are based on the concept of a business office “process.” Thus, as used herein, typically a “process” (such as, but without limitation, a back office business, a contact center process, or the like) comprises a set of “tasks.” A “process” has a “start” and an “end,” and typically one or more applications may be used to carry out the process. An employee (or, more generally, an “agent”) may operate on several business processes concurrently. Likewise, a business process may be “touched” by multiple employees after it is starts and before it is complete. An example process would be a “trouble ticket” process having a particular unique work item identifier (e.g., trouble ticket #1234). This particular work item process may be initiated by a first agent, who may then pass the work item to a second agent, and so on, until the business process step is completed. A particular task within the process instance may also require access to another entity's application via a remote access session. According to this disclosure then, a process to handle a unique work item may be carried out by more than one agent, and it may include one or more tasks, each of which may be carried out using applications that execute on a desktop (a particular agent's desktop, or a desktop remotely accessible to the agent).

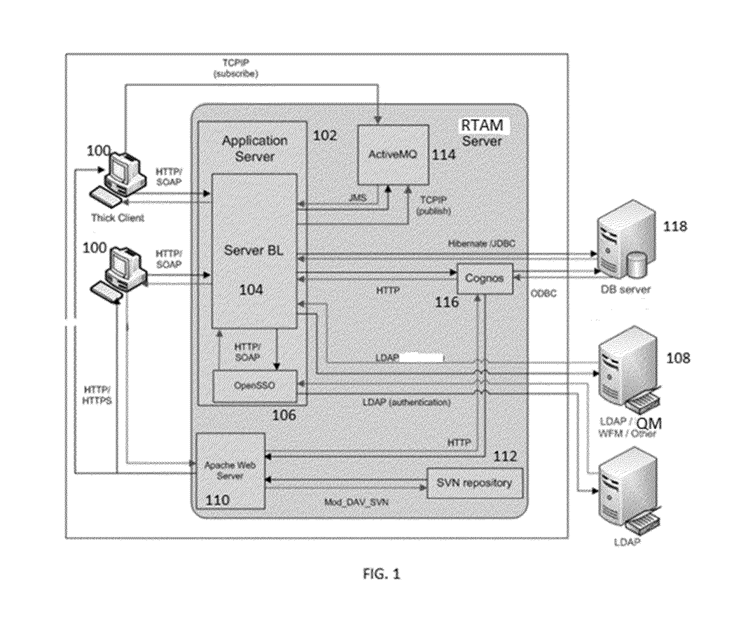

With the above as background, FIG. 1 illustrates a representative computer architecture in which the disclosed subject matter may be implemented. This architecture is not intended to be limiting.

Typically, the architecture is located within an enterprise firewall (or other secure boundary), however, this is not a limitation either. Portions of the architecture may reside externally to an enterprise, and/or be implemented as a managed or hosted service offering. In an alternative implementation, portions of the architecture may be implemented in the context of an information technology delivery model known as cloud computing, by which shared resources, software and information are provided over the Internet to computers and other devices on-demand. With this approach, an application instance can be hosted and made available from Internet-based resources that are accessible over HTTP through a conventional Web browser.

The various technologies illustrated in the drawing are well-known to one of ordinary skill in the art. Thus, familiarity with the various applications, protocols and functions are presumed. In a representative embodiment, the architecture shown in FIG. 1 includes a plurality of client machines 100. These are the machines that are desired to be monitored according to the real-time activity monitoring techniques of this disclosure. The client machines 100 include both “thick” and “thin” clients. In particular, it is known in the prior art to integrate Web- or cloud-based applications with so-called “thick” (or “rich”) clients, where a “thick” client is a client (of a client-server application) that supports its own interface (as opposed to merely exporting the web interface from the web application itself). A “thin” client, in contrast, typically is browser-based. An application server 102 executes server business logic 104 for the enterprise application(s), and it executes a single sign-on (SSO) application 106 to provide identity-based authentication. The application server may be implemented by Apache Tomcat, BEA® WebLogic®, IBM®WebSphere®, or the like. As is well-known, SSO is an access control mechanism which enables a user to authenticate once (e.g., by providing a user name and password) and gain access to software resources across multiple systems. Typically, an SSO application 106 enables user access to resources within an enterprise or an organization. The SSO application interacts with one or more directory servers 108, which store information about permitted users within a directory service, such as an LDAP-compliant directory. LDAP is an application protocol for querying and modifying directory services running over TCP/IP. A web server 110 provides web pages (both in the clear and over secure transport) and other HTTP-based objects to the clients. Web server 110 interacts with a version control repository 112. A middleware server 114 (such as one based on IBM® MQSeries® technologies) manages communications across the different platforms. A reporting server 116 (such as implemented commercially by Cognos®) uses an associated database server 118, and these servers provide a database schema to facilitate report generation as well as storing business logic, configuration data and administration information. The database supports known database management systems, such as Oracle® 10g, Microsoft® SQL Server, MySQL, or the like. Reports may be generated as web pages that are then displayed to permitted users, such as back office supervisors and managers. As indicated, where appropriate, communications across the architecture may be encrypted (e.g., using SOAP over HTTPS). Typically, client-server interactions within the architecture are formatted to conform to the Simple Object Access Protocol (SOAP) and travel over HTTP, or to any other reliable transport mechanism, as illustrated.

Employee “desktops” as used herein should be broadly construed to include conventional desktops, laptops, notebook computers, as well as tablets, smart phones and other mobile devices. A desktop machine may be coupled to any other entity within the disclosed architecture in any known manner, including via wire-line and wireless networks.

The system may include a mechanism to create, store, assign, and download to the client one or more “solution” files, which describe the work items. Preferably, solution files are created, stored on the server, assigned to employees based on the nature of the work they do, and then downloaded to the client desktop based on the employee assignments.

The real-time activity monitor (RTAM) of this disclosure may be implemented as a client-server application. Typically, and as will be seen, the client-side of the application executes on or in association with a client machine 100, and the server-side of the application executes on or in association with the application server 102 and/or the web server 110.

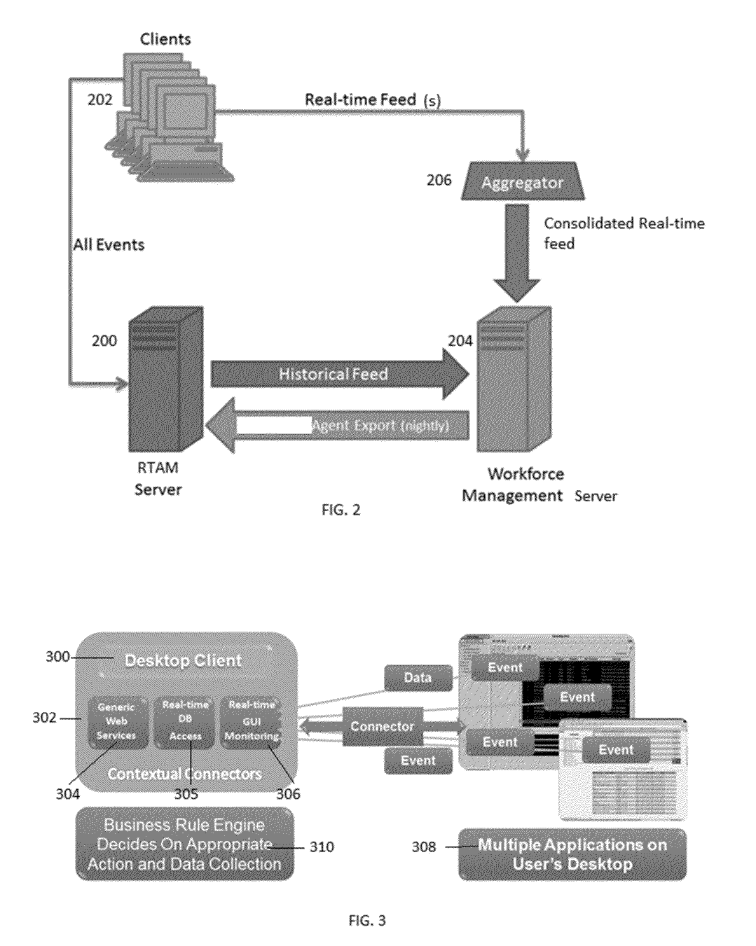

In an enterprise (e.g., back office) environment, typically employees are primarily responsible for completing work items. These work items can be any combination of discrete work units, such as processing faxes, claims, cases, tickets, and the like, to handle a work item. It is desirable to monitor employees as they carry out (or fail to carry out) these activities so as to provide management (or others) with information regarding workflow and efficiencies. In one embodiment, and as will be described, the RTAM subject matter herein is implemented within or in conjunction with a back office suite of applications. These applications enable data collection and analysis from the back office, and they may provide that data to a Workforce Management (WFM) system to facilitate forecasting, scheduling, change management and performance management. A representative WFM system is IEX TotalView®, which is a commercial system marketed by IEX Corporation, Richardson, Tex. The back office suite may comprise an RTAM application. The RTAM application typically comprises desktop process monitor, desktop application monitor and employee work journal modules to enable the collection and reporting of information from any agent desktop application, which data can then be viewed in system screens and reports in a meaningful way. One of more of these modules may be integrated. FIG. 2 illustrates a representative implementation. In this example embodiment, the servers host two (2) different platforms. An RTAM server 200 communicates with clients 202 on employee desktops. Server 200 receives real-time information about processes and active applications, and that data is stored within an associated server database. Preferably, the information received from the employee desktop machines is packaged by the RTAM server 200, and this server 200 also may be configured to send historical feeds to populate queue history on the workforce management (WFM) server 204. This enables the collected data to be used to facilitate WFM tasks. As illustrated, each client 202 also may be configured send real-time active application information to an aggregator machine or function 206. Preferably, the aggregator 206 consolidates the real-time messages from multiple clients and appears as a single real-time feed to populate real-time enabled display views exported by the workforce management server 204.

FIG. 3 illustrates the high level operation of the desktop process monitor and application process monitor of this disclosure. The monitors may be discrete functions or operations, or they may be integrated. In the illustrated embodiment, a desktop client application 300 executes within or in association with the client machine and provides a set of contextual connectors 302. The connectors 302 include a generic web services connector 304, a real-time database access connector 305, and a real-time graphical user interface (GUI) monitoring connector 306. The connectors may be discrete software modules, or they may be integrated. The real-time GUI monitoring connector 306 operates to monitor data and events occurring with respect to multiple applications 308 that are executing on the user's desktop. Typically, and as is well-known in the context of a multi-tasking operating system, it is possible to open and run multiple applications within a single desktop operating environment. An individual employee may have several back office applications open, while at the same time be connected to his or her Facebook page, personal e-mail (such as Gmail), and the like. As a consequence, the execution of multiple applications in this manner generates numerous GUI and application-related events and data. The real-time GUI monitoring connector 306 captures such events and data, and it provides such information to a business rule engine 310 that decides on an appropriate action. As needed, the desktop client 300 uses the generic web services connector 302 and the real-time database access connector to obtain data from other sources, and/or to provide the collected data to other sources.

As illustrated, the desktop client is typically loaded locally on the end-user's workstation. In the alternative, the client is located on a remote access server in the case of a remote access configuration. Control and data files are retrieved from the application server (such as server 200, in FIG. 2) and loaded by the client. Once loaded, the client is then configured and executes one or more business rules (in the business rules engine 310) required to support the real-time activity monitoring through the connected applications.

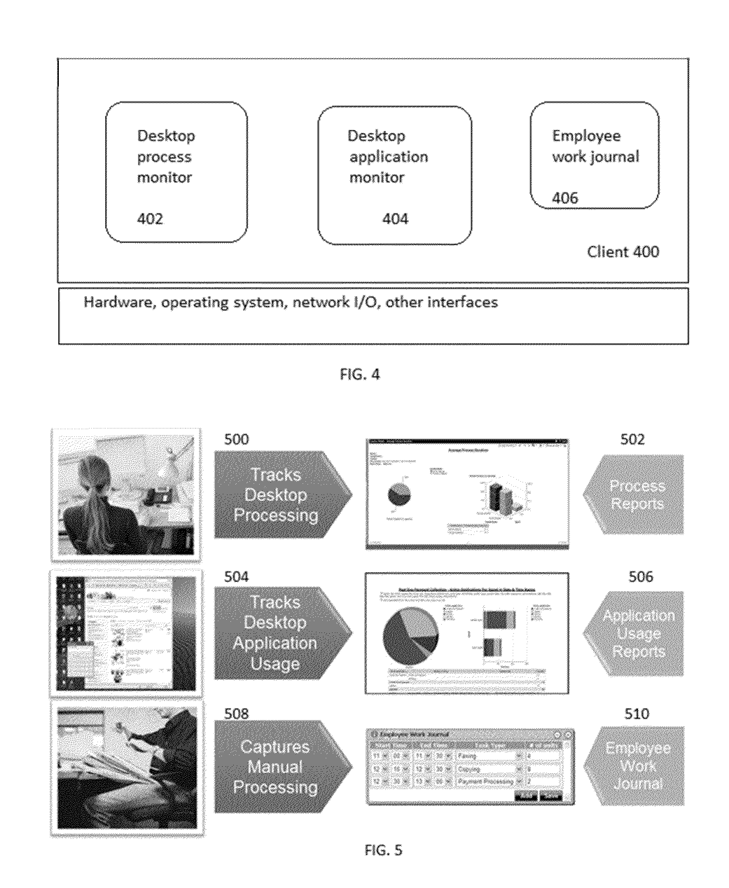

As seen in FIG. 4, the desktop client 400 typically comprises a desktop process monitor 402, and a desktop application process monitor 404, and an employee work journal 406. As noted above, these monitors and work journal may be discrete, or they may be integrated. The desktop process monitor (or “DPM”) 402 typically runs in the background on the employee's workstation while he or she goes about his or her normal business activities. As active applications change, the illustrated components monitor applications and their states to determine the start and stop times of defined business processes performed by the employee. Moreover, and as will be seen, the DPM also tracks in-process pauses, idle time, and screen lock time to report actual handle times for the tasks that make up a complete process. The desktop application monitor 404 (or “DAM”) is used to monitor which application an employee has in focus at any given time on the desktop. As shown in FIG. 2, this stream of information is used to populate the real-time feed to a workforce management (WFM) system. If desired, an analysis of this feed may be performed in a real-time adherence view in a workforce management (WFM) display tool.

As seen in FIG. 5, the desktop process monitor tracks desktop processing 500 and produces process reports 502. The application process monitor tracks desktop application usage 504 and produces application usage reports 506. If desired, the employee work journal feature may also capture manual processing activities 508 and produce employee work journals 510.

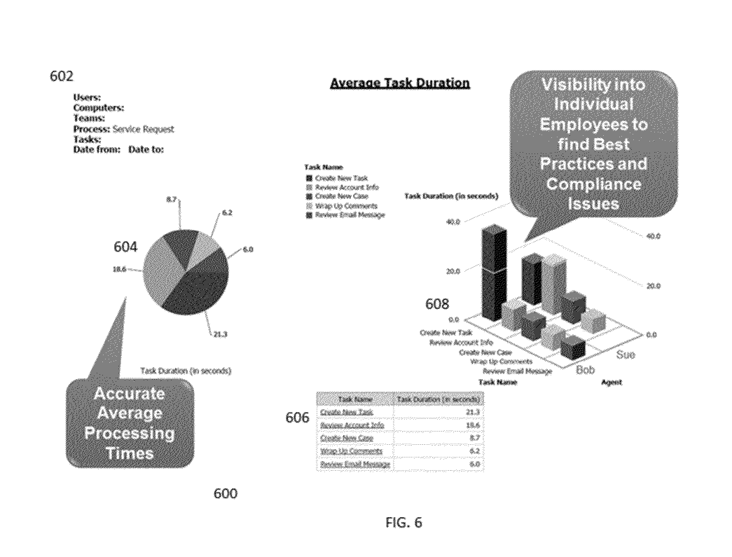

FIG. 6 illustrates a representative Average Task Duration display view generated by the DPM data collection method. As seen in FIG. 6, the “process” in this example is a so-called “Service Request” process that comprises a set of back office tasks that are also shown, namely: Create New Task, Review Account Info, Create New Case, Wrap-Up Comments, and Review Email Message. Of course, these tasks are merely representative. Using the data collection technique described, the collected data is processed and used to populate the display view that is then rendered. The view may be rendered as a web page, as a display report, or otherwise. The particular layout and format of the display is representative and not intended to be taken by way of limitation. As can be seen, the display view 600 includes summary or overview metadata 602, a pie chart 604 representation of the tasks in the process, a task duration table 606, and an agent-based task comparison view 608. The metadata 602 shows how the data can be shown for various users, teams, processes, tasks, date ranges and the like, which allows the user to view a very large or small dataset. The pie chart 604 compares the average processing times for the tasks that comprise the service request process, and the task duration table 606 identifies the actual average task time data, preferably in a linked (URL) format that provides a navigation path to the underlying data (or other views). The task comparison view 608 can be configured by the user to compare at least first and second employees (in this case, “Bob” and “Sue”), in this case on a side-by-side basis. The resulting 3D display view enables the operator to compare and contrast the performance of the employees with respect to the Service Request process. This display thus provides significant visibility into individual employee performance to facilitate determination of employee best practices and to further satisfy compliance-related issues.

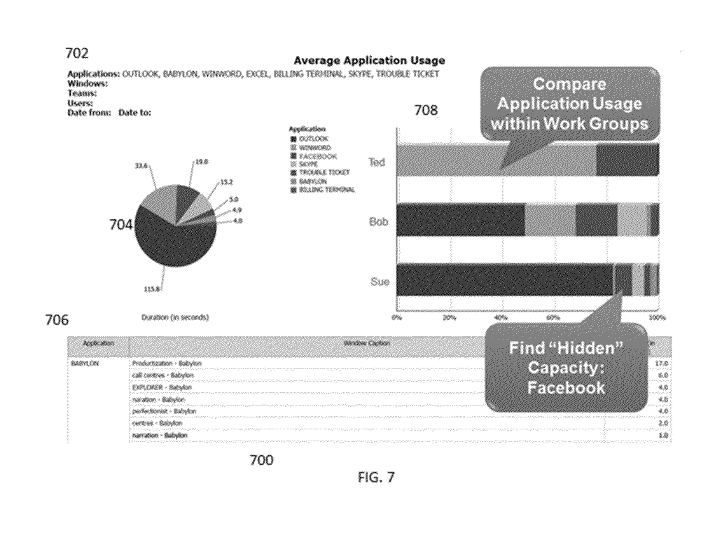

FIG. 7 illustrates a representative display view generated by the DAM application data collection method. As can be seen in this example, desktop work involves a number of various applications, including: Microsoft Outlook, Microsoft Word, a Trouble Ticket application, a Babylon application and others. Of course, it may be the case that the employee has opened such additional applications even if they are not required for handling work items. The employee may have his or her web browser persistently for non-work-related activities. As can be seen, the display view 700 includes summary or overview metadata 702, a pie chart 704 representation of the applications identified, an application usage table 706, and an agent application usage comparison view 708. The pie chart 704 compares the average application usage times for the applications identified, and the application usage duration table 706 identifies the actual average application usage data, preferably in a linked (URL) format that provides a navigation path to the underlying data (or other views). The application comparison view 708 can be configured by the user to compare at least first and second employees (in this case, “Ted,” “Bob” and “Sue”), in this case on a side-by-side basis. In this case, the individual employees are members of a workgroup. Each bar graph illustrates the various applications identified showing their percentage (and thus their relative usage). Non-work time (in this case, Facebook page checking), which can equate to hidden capacity to do more work, is readily identified. Using this approach, the operator can compare what applications are being opened and used by the employees within or across a particular workgroup or otherwise. This display thus provides significant additional visibility into individual employee performance, once again to facilitate determination of employee best practices and to further enable the satisfaction of compliance-related issues.

Many business work items need not be handled on a computing machine, such as a client desktop. For example, a work item may simply involve opening a piece of mail and scanning it into an image system, making a copy, sending a fax, or the like. An enterprise also has an interest in understanding this type and volume of work, which agents are performing it, whether it is growing or shrinking, how it impacts more traditional computer-based work, and the like. To this end, the employee work journal (such as shown in FIG. 4) is provided to allow an employee to enter his or her own manual work items. In some cases, an employee's supervisor may want to validate the entries in the employee's journal and enter this data into the system. The employee work journal enables this data collection and integration with the other system data described.

Thus, according to the disclosure, the process and application monitors track application and web page usage, even across remote environments. Processes and tasks executing in association with the process are tracked with respect to the agents' actions at the desktop, and the collected data may be processed through one or more business rules for storage and to generate intelligent display views. Using these views, an operator (such as a manager) can determine if an employee is working most efficiently, who is not working, what application(s) an employee is using, and so forth.

As illustrated in FIG. 6, and as noted above, the data collection and display technique herein is based on the construct of a business “process.” As noted, a process typically represents a step in handling a work item. Processes comprise a single task, or multiple tasks. As used herein, a process typically has a set of properties. They include the following. A unique identifier is associated with the process (or an instance of the process); the unique identifier is a specific element that unites one or more discrete tasks with the overall process with which the tasks are associated. A start condition is an event on the employee's desktop which initiates the process. A pause (or a hold) condition is an event on the employee's desktop that indicates a pause in the current process, such as might occur by the opening of a non-relevant application. A stop condition is an event on the employee's desktop that indicates the current process has been completed, or halted. A task is a desktop interaction that occurs within the process when the start condition is true. Preferably, only one task is active at a time. A queue tag may be used to associate the process with a particular workforce management (WFM) queue, thereby allowing an employee with multiple skills to handle different types of work and track them separately. Tracking them as separate work types allows them to be forecast separately in a WFM system.

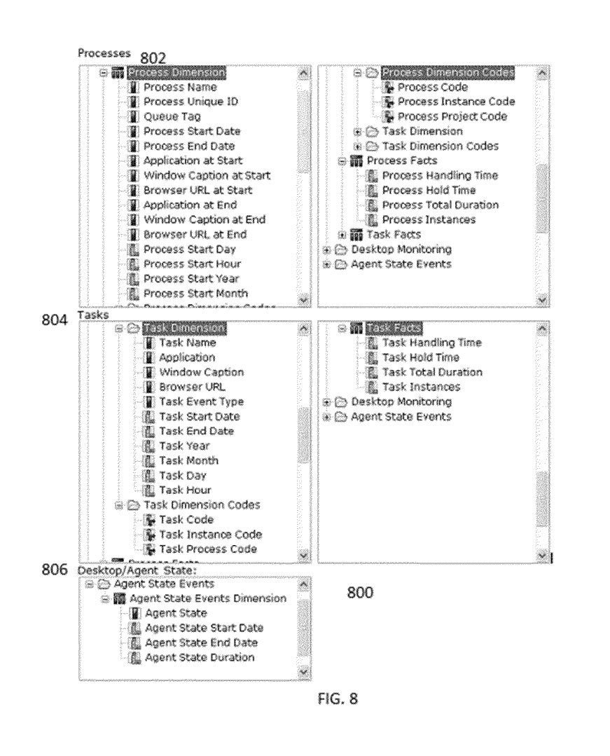

FIG. 8 illustrates a process monitoring model 800 that may be implemented according to this disclosure. The model 800 comprises Processes 802, Tasks 804, and Desktop/Agent States 806. As can be seen, according to this model, a Process has a Process Dimension that comprises a number of self-defined attributes: Process Name, Process Unique ID, Queue Tag, Process Start Date, Process End Date, application at Start, Browser URL at Start, application at End, Window Caption at End, Browser URL at End, Process Start Day, Process Start Hour, Process Start Year, Process Start Month, and so on. The Processes 802 in the model also comprise Process Dimension Codes including a Process Code, a Process Instance Code, and a Process Project Code as well as Process Facts including a Process Handling Time, Process Hold Time and a Process Total Duration. A Task 804 comprises a Task Dimension that comprises a number of self-defined attributes: Task Name, application, Window Caption, Browser URL, Task Event Type, Task Start Date, Task End Date, Task Year, Task Month, Task Day, and Task Hour. The Task model also includes Dimension Codes that include a Task Code, a Task Instance Code, and a Task Process Code. Task Facts include Task Handling Time, Task Hold Time, Task Total Duration, and Task Instances. The Desktop/Agent States 806 in the model comprises an Agent State Events Dimension that comprises a number of self-defined attributes: Agent State, Agent State Start Date, Agent State End Date, and Agent State Duration. The following Agent States are representative and without limitation: logged-in, active, hold, idle, lock. These states are defined as:
Logged-in: the employee has logged in but is not in any process (active task or hold) and the desktop is not idle or locked.
Active task: the employee is performing active task of any process
Hold: the employee is in any process but not performing any active task
Idle: the desktop is idle, or the employee is in a process that is idle (and there is no other active task or process hold)
Lock: the desktop is locked.

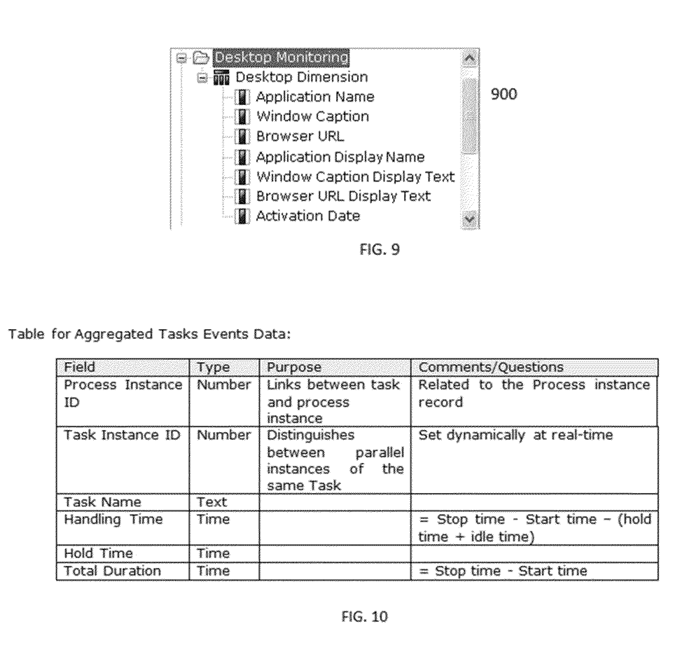

FIG. 9 illustrates an application usage model 900. This model comprises a Desktop Dimension that comprises a set of self-defined attributes: application Name, Window Caption, Browser URL, application Display Name, Window Caption Display Text, Browser URL Display Text, Activation Date, and so forth.

FIG. 10 illustrates a table defining the data structures for aggregating task event data according to the above-described data model.

As one of ordinary skill will appreciate, the desktop client connectors capture events and data as the employee performs activities with respect to one or more of such business processes while working on his or her desktop. As such work is being performed, applications are being opened and closed, windows are brought into and out of focus, data is entered, and so forth. Meanwhile, under the covers the data connectors capture the data and associated process/application state changes so that the resulting data can be processed and displayed in the manner shown in FIGS. 6-7 (or otherwise output from the system in any convenient manner).

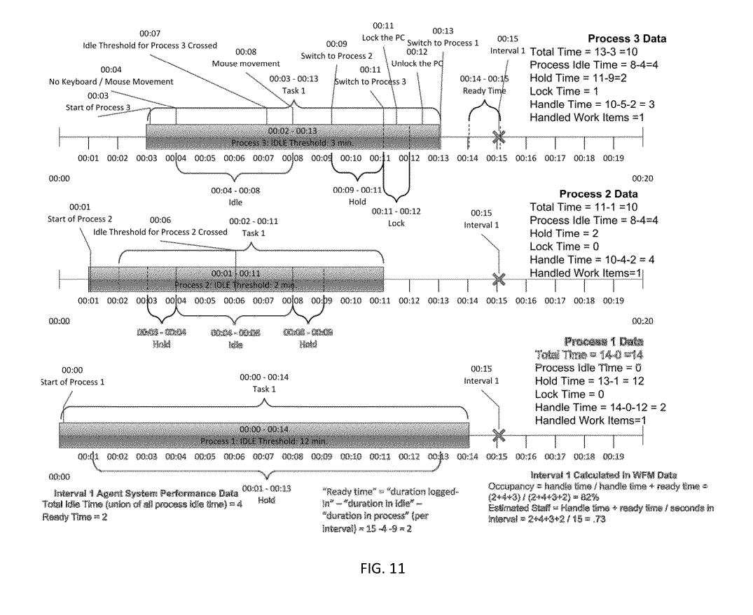

FIG. 11 illustrates the data as captured from a complex operating scenario involving three (3) concurrent processes, titled Process 1, Process 2, and Process 3. As the display views illustrate, in this operating scenario, Process 1 was initiated at time 00:00 and continued for a period of fourteen minutes (or until time 00:14). Throughout this period, Task 1 was being performed, although the fine-grained data also reveals that, in effect, the Task actually was put on “Hold” for most of this time (namely, between the period lasting from time 00:01 to time 00:13. The reason for this Hold is evident from the rest of the display view. In particular, at time 00:01, the employee started working on Process 2. Process 2 event data is captured and shows that the employee worked on Process 2 for just a few minutes (or until time 00:03), when he or she began work on Process 3 (at time 00:03). Process 2 and Process 3 each involve potential periods of inactivity designated by the events referred to as Hold, Idle and Lock. In this example, Process 3 involved a number of events, such as movement of a mouse cursor, locking of the PC, unlocking the PC, and so forth. As can be seen, after moving away from Process 1 and opening Process 2, the employee then started Process 3. He then returned (to complete Process 2), then he returned back to complete Process 3, and then, finally, he returned back to complete Process 1. The resulting events and data are all captured and the resulting statistics provide an accurate description of the actual work involved. These statistics include, for example, Total Time, Process Idle Time, Hold Time, Handle Time, Lock Time and Handled Work Items. This process data is supplied to populate the display views. In addition, if desired the information (or portions thereof) may also be supplied to the workforce management (WFM) system to generate WFM-specific data metrics (e.g., applicable occupancy data and estimated staff metrics for the particular quarter-hour time interval illustrated). The time intervals used for providing WFM-specific data could be quarter-hour, half-hour, hour or other time increment without limitation.

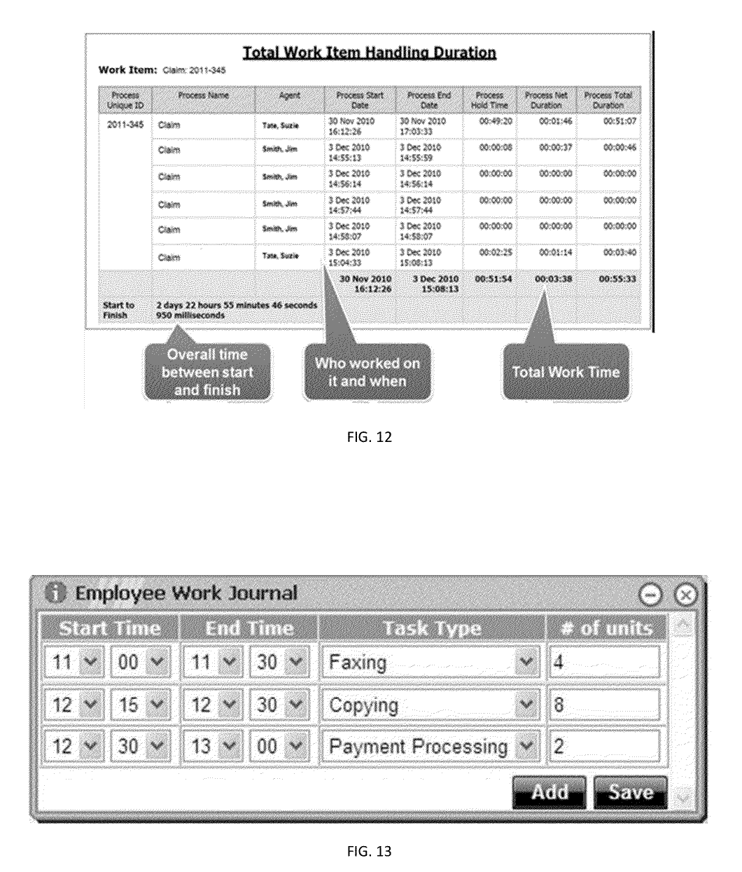

FIG. 12 illustrates a represent display screen or output report that illustrates the total work item handling duration for a particular work item that is worked on by multiple employees. The process unique identifier represents a single work item that, in this example, is worked on by several different agents on different dates and times, as indicated. The display/report includes a process net duration column, the result of which is a total work time for the work item that is worked on by multiple distinct agents over multiple process start-end dates and times.

FIG. 13 is a representative display screen for use as an input mechanism for the employee work journal. The data entry process typically is a manual process. As can be seen, using a fill-in form mechanism (such as an HTML form with a set of drop-down list entries as shown), the agent (or a person acting on the agent's behalf) can identify the start and stop times for a particular task, and a number of associated work units. Once saved, the data comprises an employee work journal, and such data may be integrated with and visualized with other data collected, as work item(s) are addressed within the enterprise environment.

As can be seen, the disclosed monitoring technique enables much more fine-grained data capture and display visualization as compared to known techniques. This data shows the actual work done by the employee with respect to each of the concurrent-handled business processes.

The disclosed technique is not limited to data collection with respect to a single agent or employee. As noted above, a particular work item may be handled out by multiple agents using resources located across multiple desktops within and possibly without the enterprise. Because each work item has its associated unique identifier, tracking information associated with the unique identifier enables the system to accurately track and visualize handling times with respect to the process instances and their related tasks associated with a business process instance, even in a scenario in which one or more of such instances are carried out by first and second distinct agents. An example scenario is the handling of a trouble ticket (one type of work). Assume, for example, that work item 1234 is handled initially by agent A, who hands off the ticket to agent B, who remotely accesses an application at another company (this is a common occurrence of outsourcers that handle work item processing for other companies), before closing out the ticket. In this scenario, the data collection techniques described herein enable the system to determine the handling times of the individual process instances of the work item, as well as the overall handling time for the work item itself, despite the fact that the process instances were carried out by multiple agents.

As noted above, one or more tasks associated with execution of a business process instance may be performed over a remote access session. Familiarity with remote access technologies and services (e.g., Citrix) are presumed. In this approach, preferably application usage events and associated business entity values are sent to a main client, which synchronizes the events and transmits a coherent stream to a data collection server. To facilitate process monitoring, the business entity data that is provided across the network connection enables the main client to manage the business logic (of the process) as if all applications were available on a single desktop. The communication may take advantage of the ability of a remote access client and desktop client to communicate based on the internal mapping of the remote access emulator on the physical user desktop to the remote access server it has an open session on.

The disclosed technique provides significant advantages it that it enables the enterprise (in general) or the operator (in particular) to track employee productivity accurately so as to improve operational efficiencies in the workplace. The techniques enable fine-grained tracking and management of employee performance. The data collection techniques are readily integrated with other performance management and scheduling systems, which enables improved forecasting and scheduling for back office, middle office and front office. Many organizations have work that blurs the lines between the front office and back office. Where the front office has direct customer contact and some non-customer contact work, the back office is typically non-customer contact work. Therefore, the term, “middle office”, has been created to describe work that involves both customer contact and non-customer contact work. Regardless, RTAM provides benefits for all departments regardless of whether they do front, middle or back office work. The display views provide a better overall view of work levels and staffing levels.

The subject matter of this disclosure may be added to a workforce management system, a back office system, a performance management system, a quality management system, or the like, as an add-on option. Or, it may be implemented as a standalone application, or a hosted (managed) service. It also provides a new tool for managing agent performance (performance management) and agent quality of service (quality management).

More generally, a system environment in which the method and system of the invention may be implemented includes a set of computing-related entities (systems, machines, processes, programs, libraries, functions, or the like) that facilitate or provide an agent-supervisor network. In a typical implementation, the environment typically comprises a set of computers. A representative machine is a client workstation or a network-based server running commodity (e.g. Pentium-class) hardware, an operating system (e.g., Linux, Windows 2000, OS-X, Ubuntu, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Google Chrome, Apple Safari, Mozilla Firefox, or the like) or other rendering engine. A Web browser typically includes or supports media players and other plug-ins. Conveniently, information may be provided on a workstation using a Java-based applet or application.

It is further noted that, unless indicated otherwise, all functions described herein may be performed in either hardware or software, or any combination thereof. In a preferred embodiment, the functions are performed by one or more processors executing given software.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The disclosed subject matter can take the form of an entirely hardware embodiment, an entirely software embodiment, or an embodiment containing both hardware and software elements. In one preferred embodiment, the rule definition interface and data state sequence comparisons are implemented in software executing in one or more server machines. Each server may have one or more processors. The disclosed subject matter (or portions thereof) may take the form of a computer program product accessible from a computer-usable or computer-readable medium providing program code (instructions) for use by or in connection with a computer or any instruction execution system. A computer-usable or computer readable medium can be any device or apparatus that can store the program for use by or in connection with the instruction execution system, apparatus, or device. The computer-usable or computer readable medium is tangible. The medium can be an electronic, magnetic, optical, or the like. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

Having described our invention, what we now claim is as follows.

1. A computer-readable medium having stored thereon instructions that, when executed by a processor, direct a data processing system associated with an agent desktop machine to:
monitor one or more applications and their states on the desktop machine;
track events associated with one or more business processes performed by the agent using the applications; and
generate data identifying handle times for one or more tasks that comprise each of the one or more business processes.

2. The computer-readable medium as described in claim 1 wherein the events include one of: a process start time, a process end time, and an in-process pause time.

3. The computer-readable medium as described in claim 1 wherein the business processes comprises first and second business processes, wherein at least a portion of the second business process is performed by the agent concurrently with at least a portion of the first business process.

4. The computer-readable medium as described in claim 1 wherein the handle times are average handle times.

5. The computer-readable medium as described in claim 1 further directing the data processing system to generate a report displaying a visualization of the handle times for the one or more tasks.

6. The computer-readable medium as described in claim 5 further directing the data processing system to generate a report displaying a visualization of the handle times for the one or more work items for the agent and a second agent.

7. The computer-readable medium as described in claim 1 further directing the data processing system to generate data identifying usage of one or more applications as a particular business process is performed by the agent.

8. The computer-readable medium as described in claim 7 further directing the data processing system to generate a report displaying a visualization of the one or more applications as a particular business process is performed by the agent and a second agent.

9. The computer-readable medium as described in claim 1 further directing the data processing system to provide a workforce management system the data identifying handle times for one or more tasks.

10. The computer-readable medium as described in claim 1 wherein the monitoring determines which application is in focus at a particular time as a business process is performed by the agent.

11. The computer-readable medium as described in claim 1 wherein at least one task is carried out over a remote access session.

12. A computer-readable medium having stored thereon instructions that, when executed by a processor, direct a data processing system associated with first and second agent desktop machines to:
track events associated with a unique work item as one or more business process instances associated with the work item are performed by respective first and second agents on their respective first and second agent desktop machines; and
generate data identifying handle times for the one or more business process instances associated with the unique work item;
wherein at least one business process instance associated with the work item is performed on the first agent desktop machine by the first agent, and at least one business process instance associated with the work item is performed on the second agent machine by the second agent.

13. The computer-readable medium as described in claim 12 wherein the unique work item has associated therewith a unique identifier.

14. The computer-readable medium as described in claim 12 wherein at least one business process instance associated with the work item is carried out over a remote access session.

15. The computer-readable medium as described in claim 12 further directing the data processing system to generate a report displaying a visualization of the handle times for the one or more business process instances.

16. The computer-readable medium as described in claim 14 further directing the data processing system to generate a report displaying a visualization of the handle times for the one or more business process instance for each of the first and second agents.

17. The computer-readable medium as described in claim 12 further directing the data processing system to generate data identifying usage of one or more applications as the business process instance is performed.

18. The computer-readable medium as described in claim 16 further directing the data processing system to generate a report displaying a visualization comparing the one or more applications used by each of the first and second agents as the business process instances are performed.

19. A computer-readable medium having stored thereon instructions that, when executed by a processor, direct a data processing system associated with an agent desktop machine to:
track events associated with first and second business processes performed by the agent using the applications, wherein at least a portion of the second business process is performed by the agent concurrently with at least a portion of the first business process; and
generate data identifying handle times for one or more tasks that comprise each of the one or more business processes.
